(19) United States
(12) Patent Application Publication
(10) Pub. No.: US 2026/0244349 A1
(43) Pub. Date: Aug. 20, 2026

(54) APPARATUS AND AN OPERATION METHOD FOR CHECKING POWER LOSS PROTECTION DUMP FAILURE

(71) Applicant: SK hynix Inc., Gyeonggi-do (KR)

(72) Inventors: Sang Min KIM, Gyeonggi-do (KR); Geon Woo KIM, Gyeonggi-do (KR); Sang Yong LEE, Gyeonggi-do (KR)

(21) Appl. No.: 19/271,794

(22) Filed: Jul. 17, 2025

(30) Foreign Application Priority Data
Feb. 14, 2025 (KR) 10-2025-0019131

(51) Int. Cl. G06F 3/06

(52) U.S. Cl. CPC G06F 3/0619; G06F 3/0659; G06F 3/0679

(57) ABSTRACT

A memory system includes a memory device including at least one data storage area and a memory controller. The memory controller is configured to, through at least one processor, perform a plurality of tasks corresponding to input/output commands for storing write data in the memory device or outputting stored data from the memory device, and add first information regarding a time point associated with an operation or function performed by the at least one processor into dump data for power loss protection.

### CROSS-REFERENCE TO RELATED APPLICATIONS

This patent application claims the benefit of Korean Patent Application No. 10-2025-0019131, filed on February 14, 2025, the entire disclosure of which is incorporated herein by reference.

### TECHNICAL FIELD

One or more embodiments of the present disclosure described herein relate to a memory system, and more particularly, to an apparatus and a method for checking a data write failure during a power loss protection operation performed within the memory system.

### BACKGROUND

A data processing system including a memory system or a data storage device has been developed to store more data in the data storage device, store data in the data storage device more quickly, and output data stored in the data storage device more quickly. The data storage device may include non-volatile memory cells and/or volatile memory cells for storing data. The memory system may perform an operation to avoid or prevent data loss when the power supplied is unstable or interrupted.

### BRIEF DESCRIPTION OF THE DRAWINGS

The description herein makes reference to the accompanying drawings wherein like reference numerals refer to like parts throughout the figures.

FIG. 1 illustrates a data processing system according to an embodiment of the present disclosure.

FIG. 2 illustrates a memory device according to an embodiment of the present disclosure.

FIG. 3 illustrates a power-related device according to an embodiment of the present disclosure.

FIG. 4 illustrates an operation for power loss protection (PLP) in a memory system according to an embodiment of the present disclosure.

FIG. 5 illustrates additional information for power loss protection (PLP) according to an embodiment of the present disclosure.

FIG. 6 illustrates a validation procedure of a write operation (PLP Dump) for power loss protection (PLP) based on the additional information for power loss protection (PLP) according to an embodiment of the present disclosure.

FIG. 7 illustrates an operation for power loss protection (PLP) according to an embodiment of the present disclosure.

### DETAILED DESCRIPTION

Various embodiments of the present disclosure are described below with reference to the accompanying drawings. Elements and features of this disclosure may be configured or arranged differently to form other embodiments, which may be variations of any of the disclosed embodiments.

In this disclosure, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like are intended to mean that any such features are included in one or more embodiments of the present disclosure, but may or may not necessarily be combined in the same embodiments.

In this disclosure, the terms "comprise," "comprising," "include," and "including" are open-ended. As used in the appended claims, these terms specify the presence of the stated elements and do not preclude the presence or addition of one or more other elements. Furthermore, the terms in a claim do not foreclose the apparatus from including additional components, e.g., an interface unit, circuitry, etc.

In this disclosure, various units, circuits, or other components may be described or claimed as “configured to” perform a task or tasks. In such contexts, “configured to” is used to connote structure by indicating that the blocks/units/circuits/components include structure (e.g., circuitry) that performs one or more tasks during operation. As such, the block/unit/circuit/component can be said to be configured to perform the task even when the specified block/unit/circuit/component is not currently operational, e.g., is not turned on nor activated. The block/unit/circuit/component used with the "configured to" language includes hardware, for example, circuits, memory storing program instructions executable to implement the operation, etc. Additionally, "configured to" can include a generic structure (e.g., generic circuitry) that is manipulated by software and/or firmware (e.g., an FPGA or a general-purpose processor executing software) to operate in a manner that is capable of performing the task(s) at issue. "Configured to" may also include adapting a manufacturing process (e.g., a semiconductor fabrication facility) to fabricate devices (e.g., integrated circuits) that are adapted to implement or perform one or more tasks.

As used in this disclosure, the term 'circuitry' or ‘logic’ refers to all of the following: (a) hardware-only circuit implementations (such as implementations in only analog and/or digital circuitry) and (b) combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions and (c) circuits, such as a microprocessor(s) or a portion of a microprocessor(s), that require software or firmware for operation, even if the software or firmware is not physically present. This definition of 'circuitry' or ‘logic’ applies to all uses of this term in this application, including in any claims. As a further example, as used in this application, the term "circuitry" or “logic” also covers an implementation of merely a processor (or multiple processors) or a portion of a processor and its (or their) accompanying software and/or firmware. The term "circuitry" or “logic” also covers, for example, and if applicable to a particular claim element, an integrated circuit for a storage device.

As used herein, the terms "first," "second," "third," and so on are used as labels for nouns that they precede, and do not imply any type of ordering (e.g., spatial, temporal, logical, etc.). The terms "first" and "second" do not necessarily imply that the first value must be written before the second value. Further, although the terms may be used herein to identify various elements, these elements are not limited by these terms. These terms are used to distinguish one element from another element that otherwise has the same or similar names. For example, a first circuitry may be distinguished from a second circuitry.

Further, the term "based on" is used to describe one or more factors that affect a determination. This term does not foreclose additional factors that may affect a determination. That is, a determination may be solely based on those factors or based, at least in part, on those factors. Consider the phrase "determine A based on B." While in this case, B is a factor that affects the determination of A, such a phrase does not foreclose the determination of A from also being based on C. In other instances, A may be determined based solely on B.

Herein, a data entry, an entry of data, an item of data, or a data item may be a sequence of bits. For example, the data entry may include the contents of a file, a portion of the file, a page in memory, an object in an object-oriented program, a digital message, a digital scanned image, a part of a video or audio signal, metadata or any other entity which can be represented by a sequence of bits. According to an embodiment, the data entry may include a discrete object. According to another embodiment, the data entry may include a unit of information processed or handled for a data input/output operation. According to another embodiment, the data entry may include a unit of information within a transmission packet between two different components.

An embodiment of the present disclosure can provide a memory system, a data processing system, and an operation process or a method, which may quickly and reliably process data into a memory device by reducing operational complexity and performance degradation of the memory system, thereby enhancing usage efficiency of the memory device.

Embodiments of the present disclosure can provide a device and an operating method for recording data required for a memory device for a certain period of time before power is turned off by performing an operation and a mechanism for power loss protection (PLP) through an auxiliary power source such as a capacitor when a memory system receiving power from an external source experiences power instability or power interruption (e.g., Sudden Power Loss, SPL).

In addition, an embodiment of the present disclosure can provide a device and a method for determining the consistency of the stored data and recovering the latest data when power is restored or supplied to the memory device through the power loss protection (PLP).

Further, in an embodiment of the present disclosure, when a problem occurs during an operation for power loss protection (PLP) so that a write operation (PLP Dump) for power loss protection (PLP) might not be performed normally, data for the power loss protection (PLP) cannot be stored or secured safely. In order to address a problem occurring during a recovery process after power is supplied, validity of data for the power loss protection (PLP) can be determined or verified based on processing time information included in data for the power loss protection (PLP), thereby improving the efficiency of the recovery operation.

In an embodiment, a memory system can include a memory device including at least one data storage area; and a memory controller configured to, through at least one processor, perform a plurality of tasks corresponding to input/output commands for storing write data in the memory device or outputting stored data from the memory device, and add first information regarding a time point associated with an operation or function performed by the at least one processor into dump data for power loss protection.

The at least one processor can include N processors. The N processors can independently perform the plurality of tasks. The first information can include information regarding a time taken for the N processors to perform the plurality of tasks.

The memory device can include a first memory block designated for the power loss protection. The memory controller can be configured to store the dump data including the first information in the first memory block.

The memory controller can be configured to generate the first information for each of the input/output commands. The first information can indicate a completed process in a series of processes in which the input/output commands are processed within the memory controller.

The first information can include a time taken for the task performed by each of the at least one processor to be completed. The first information can include '0' or a null value when the at least one processor has not completed the plurality of tasks or the plurality of tasks has not been performed by the at least one processor.

The memory controller can be configured to: read the dump data from the memory device after power is supplied again after a power loss; and recover or restore the operating state before the power loss based on the dump data.

The memory controller can be configured to determine whether at least one of the input/output commands have failed based on the first information included in the dump data, when at least a part of the recovery or restoration fails.

The memory controller can be configured to transmit a response for the input/output command to an external device when it is determined whether at least one of the input/output commands has failed.

The memory controller can be configured to: generate an internal command other than the input/output commands; perform at least one task for the internal command through the at least one processor; and add the first information regarding the at least one task into dump data for the power loss protection.

The memory controller can be configured to: recover or restore the operating state for the internal command after power is supplied again after a power loss; and re-generate the internal command when at least a part of the recovery or restoration fails.

In an embodiment, a method of operating a memory system can include performing a plurality of tasks corresponding to input/output commands through at least one processor; monitoring a time point or a status associated with the at least one task among the plurality of tasks performed by the at least one processor; adding, into dump data, first information regarding the time point or the status associated with the at least one task or operation, after an operation for power loss protection is begun; and storing the dump data including the first information in a memory block designated for the power loss protection.

The at least one processor can include N processors. The N processors can independently perform the plurality of tasks. The first information can include information regarding a time taken for the N processors to perform the plurality of tasks.

The first information generated for each of the input/output commands can indicate a completed stage in a series of processes in which the input/output commands are processed within a controller.

The first information can include information regarding a time taken for the at least one task performed by each of the at least one processor to be completed. The first information can include '0' or a null value when a task among the plurality of tasks is not completed nor performed by the at least one processor.

The method can further include reading the dump data from the memory block after power is supplied after a power loss; and recovering or restoring an operating state before the power loss based at least on the dump data.

The method can further include determining whether at least one of the input/output commands has failed based on the first information included in the dump data, when at least a part of recovery or restoration fails; and transmitting a response to each of the input/output commands to an external device when recovery or restoration failure of each of the input/output commands is determined.

In another embodiment, a data storage device can include a power circuit configured to detect whether external power is lost or unstable and supply one of an external power source or an auxiliary power source; and a power loss protection controller configured to add first information, including an input/output command input from an external device and a time point associated with at least one task for the input/output command performed by at least one processor in response to a power loss, into dump data for power loss protection; and a non-volatile memory designated to store the dump data.

The power circuit can include a power loss detection circuit configured to detect whether the external power source is lost or unstable; an auxiliary power circuit configured to supply the auxiliary power source in response to determination of the power loss detection circuit; and a power selection circuit configured to select one of the external power source and the auxiliary power source.

The power loss protection controller can be configured to: monitor the time point associated with at least one task performed by the at least one processor for the input/output command; and generate the first information when auxiliary power is supplied through the power circuit.

The power loss protection controller can be configured to: read the dump data from the non-volatile memory after the external power is supplied after the power loss; and recover or restore an operating state of the data storage device before the power loss based on the dump data.

An embodiment described herein can provide an apparatus and a method for improving a data input/output operation of a memory system or a data processing system.

Embodiments will now be described with reference to the accompanying drawings, wherein like numbers reference like elements.

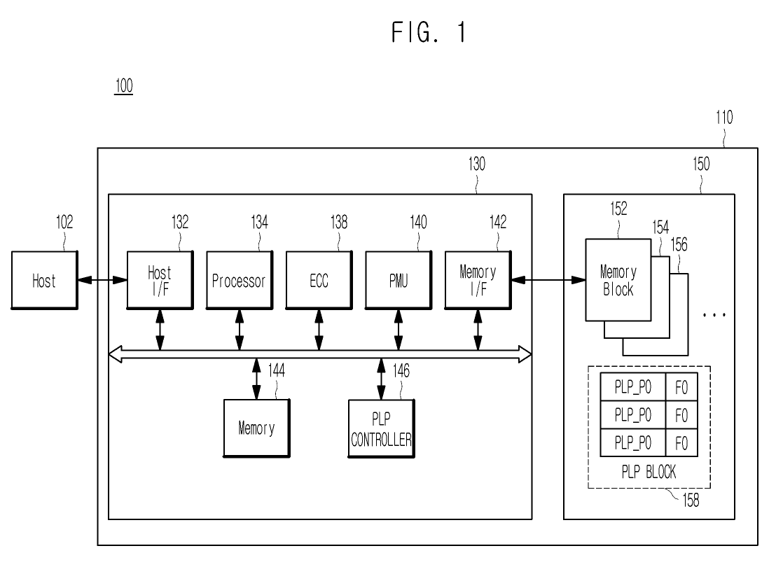

FIG. 1 illustrates a data processing system according to an embodiment of the present disclosure.

Referring to FIG. 1, the data processing system 100 can include a host 102 engaged or coupled with a memory system, such as memory system 110. For example, the host 102 and the memory system 110 can be coupled to each other via a data bus, a host cable and the like to perform data communication.

The memory system 110 can include a memory device 150 and a controller 130. The memory device 150 and the controller 130 in the memory system 110 may be considered components or elements physically separated from each other. The memory device 150 and the controller 130 can be connected via at least one data path. For example, the data path may include a channel and/or a way.

According to an embodiment, the memory device 150 and the controller 130 can be components or elements functionally divided. Further, according to an embodiment, the memory device 150 and the controller 130 can be implemented with a single chip or a plurality of chips. The controller 130 can perform a data input/output operation in response to a request input from the external device. For example, when the controller 130 performs a read operation in response to a read request input from an external device, data stored in a plurality of non-volatile memory cells included in the memory device 150 is transferred to the controller 130.

According to an embodiment, a memory die can include at least one memory plane. The memory die can be understood to be a set of components implemented on a physically distinguishable substrate. Each memory die can be connected to the controller 130 through a data path. Each memory die can include an interface to exchange an item of data and a signal with the controller 130. Additionally, the memory die can include a memory group including a plurality of non-volatile memory cells. The plurality of non-volatile memory cells can be connected via word lines and bit lines. The memory die can include a plurality of planes or a plurality of memory blocks 152, 154, 156.

The memory device 150 can include the plurality of memory blocks 152, 154, 156. The memory blocks 152, 154, 156 can be understood to be a group of non-volatile memory cells in which data is removed together by a single erase operation. Although not illustrated, the memory block 152, 154, 156 can include a page which is a group of non-volatile memory cells that store data together during a single program operation or output data together during a single read operation. For example, one memory block can include a plurality of pages.

For example, the memory device 150 can include a plurality of memory planes or a plurality of memory dies. According to an embodiment, the memory plane can be considered a logical or a physical partition including at least one memory block, a driving circuit capable of controlling an array including a plurality of non-volatile memory cells, and a buffer that can temporarily store data inputted to, or outputted from, non-volatile memory cells.

According to an embodiment, the memory device 150 can include at least one memory block 152, 154, 156, at least one memory plane, or at least one memory die. The internal configuration of the memory device 150 shown in FIG. 1 can be varied according to performance of the memory system 110. An embodiment of the present disclosure is not limited to the internal configuration shown in FIG. 1.

Referring to FIG. 1, the memory system 110 including the controller 130 and the memory device 150 can include at least one component for performing power loss protection (PLP). According to an embodiment, the memory device 150 can include a power loss protection memory block 158.

When a power loss, which may be regarded as one of the emergency situations, occurs, dump data can be generated to protect or recover the operating state of the memory system 110, a processing status of at least one command being processed, or etc. The power loss protection memory block 158 can be a storage area designated to store the dump data. Because the power loss protection memory block 158 is for storing data generated in an emergency situation, the power loss protection memory block 158 cannot store data corresponding to a data input/output command transmitted by the host 102, which is an external device. According to an embodiment, the power loss protection memory block 158 can have a preset size, which may be determined in response to a range that the memory system 110 can protect when a power loss occurs in the memory system 110. The range that the memory system 110 can protect, recover or restore can be determined in response to an auxiliary power which the memory system 110 can provide.

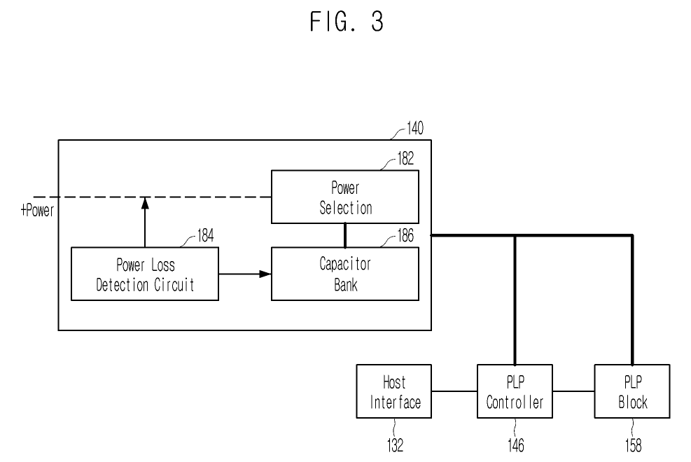

According to an embodiment, the controller 130 can include a power management unit 140 and a power loss protection controller 146. The power management unit 140 in the controller 130 can monitor power applied to the memory system 110 (e.g., a voltage supplied to the controller 130) and provide power to components included in the controller 130. The power management unit 140 can not only detect whether the power supplied from the outside is turned on or off, but also can generate a trigger signal so that the memory system 110 could urgently back up a current state when the supplied voltage level is unstable. According to an embodiment, the power management unit 140 can include a device that is capable of accumulating power that could be used in an emergency situation. The specific configuration of the power management unit 140 is described below with reference to FIG. 3.

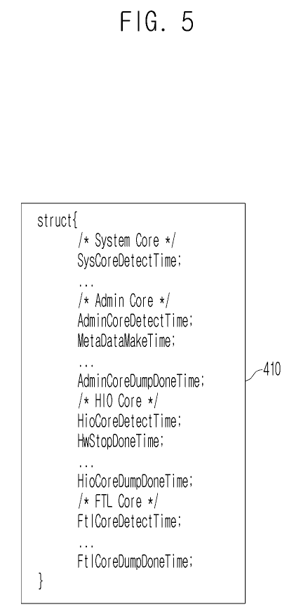

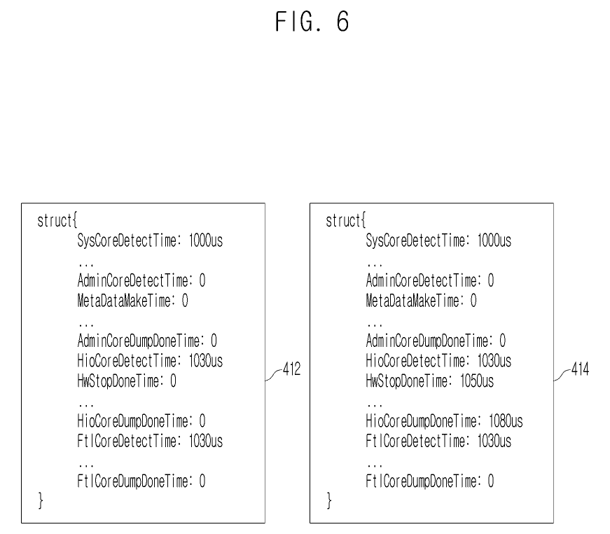

The power loss protection controller 146 can monitor operations or tasks performed by the controller 130. When the power management unit 140 determines that power has been lost, the power loss protection controller 146 can add, into dump data, information about the operations or tasks performed by the controller 130. The dump data for power loss protection (PLP) can include at least one command processed by the controller 130 and processing information about the at least one command. For example, a power loss can occur while the controller 130 is performing at least one task corresponding to a read command. The controller 130 can perform a verification operation to determine or check a validity of the read command transmitted from the host 102, which is an external device, or a validity of the logical address transmitted along with the read command. In addition, the controller 130 can perform an address translation operation to convert a logical address into a physical address. Further, the controller 130 can be configured to check various variables or flags that may be transmitted with the read command and perform an operation corresponding to characteristics or property of the command. The controller 130 can perform at least one task corresponding to the read command, and the power loss protection controller 146 can track a processor or core performing a task and/or a time taken by the processor or core to complete the task. When a power loss occurs, the power loss protection controller 146 can add, into the dump data, additional information regarding a status in which the command was processed and the time taken corresponding to the processed status. Additional information generated by the power loss protection controller 146 is described later with reference to FIGS. 5 and 6.

According to an embodiment, the controller 130 can include plural pipelines to improve the performance of data input/output operations. The controller 130 can detect and resolve various types of hazards occurring within the memory system 100. Various components within the controller 130 can interact with each other for efficient operation of the memory system 110 or the controller 130. The controller 130 can include components for detecting and resolving various types of hazards that may occur during pipeline processing within the memory system 110. Pipeline processing is a technique for improving processing speed by dividing instructions into multiple stages and processing them simultaneously, but data hazards, control hazards, and structural hazards may occur during pipeline processing. Additional information that the power loss protection controller 146 adds to the dump data can help track the process of detecting and resolving various hazards.

The host 102, which is an external device connected to the memory system 110, can include an electronic device, such as a portable electronic device such as a mobile phone, an MP3 player, a laptop computer, or a non-portable electronic device such as a desktop computer, a game console, a TV, a projector, or a central processing unit (CPU) included in a portable electronic device or a non-portable electronic device. According to an embodiment, the host 102 and the memory system 110 can constitute a computing device or a wired or wireless electronic device.

The host 102 may also include at least one operating system (OS), which can control functions and operations performed in the host 102. The OS can provide interoperability between the host 102 engaged operatively with the memory system 110 and a user who intends to store data in the memory system 110. The OS may support functions and operations corresponding to user’s requests. By way of example but not limitation, the OS can be classified into a general operating system and a mobile operating system according to mobility of the host 102. The general operating system may be split into a personal operating system and an enterprise operating system according to system requirements or a user environment. As compared with the personal operating system, the enterprise operating systems can be specialized for securing and supporting high performance computing.

The mobile operating system can be subject to support services or functions for mobility, e.g., a power saving function. The host 102 may include a plurality of operating systems. The host 102 may execute multiple operating systems interlocked with the memory system 110, corresponding to a user’s request. The host 102 may transmit a plurality of commands corresponding to the user’s requests into the memory system 110, thereby performing operations corresponding to the plurality of commands within the memory system 110.

The controller 130 in the memory system 110 can control a memory device 150 in response to a request or a command input from the host 102. For example, the controller 130 may perform a read operation to provide data read from the memory device 150 to the host 102 and may perform a write operation (or a program operation) to store data input from the host 102 in the memory device 150. To perform data input/output (I/O) operations, the controller 130 may control and manage internal operations of reading data, programming data, erasing data, or the like. A voltage supply circuit can apply a target voltage to a memory group 330 or the memory block 152, 154, 156 according to a command or request transmitted from the controller 130 to the memory device 150.

According to an embodiment, the controller 130 may include a host interface 132, a processor 134, the error correction circuitry (ECC) 138, a power management unit (PMU) 140, a memory interface 142, and a memory 144. Components included in the controller 130 illustrated in FIG. 1 may vary according to structures, functions, operation performance, or the like, regarding the memory system 110.

For example, the memory system 110 may be implemented with any of various types of storage devices, which may be electrically coupled with the host 102, according to a protocol of a host interface. Non-limiting examples of suitable storage devices include a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, a memory stick, and the like. Components may be added to or omitted from the controller 130 according to implementation of the memory system 110.

The host 102 and the memory system 110 each may include a controller or an interface for transmitting and receiving signals, data, and the like, in accordance with one or more predetermined protocols. For example, the host interface 132 in the memory system 110 may include an apparatus capable of transmitting signals, data, and the like to the host 102 or receiving signals, data, and the like from the host 102.

The host interface 132 included in the controller 130 may receive signals, commands (or requests), and/or data input from the host 102 via a bus. For example, the host 102 and the memory system 110 may use a predetermined set of rules or procedures for data communication or a preset interface to transmit and receive data therebetween. Examples of sets of rules or procedures for data communication standards or interfaces supported by the host 102 and the memory system 110 for sending and receiving data include Universal Serial Bus (USB), Multi-Media Card (MMC), Parallel Advanced Technology Attachment (PATA), Small Computer System Interface (SCSI), Enhanced Small Disk Interface (ESDI), Integrated Drive Electronics (IDE), Peripheral Component Interconnect Express (PCIe or PCI-e), Serial-attached SCSI (SAS), Serial Advanced Technology Attachment (SATA), Mobile Industry Processor Interface (MIPI), and the like. According to an embodiment, the host interface 132 is a type of layer for exchanging data with the host 102 and is implemented with, or driven by, firmware called a host interface layer (HIL). According to an embodiment, the host interface 132 can include a command queue.

The Integrated Drive Electronics (IDE) or Advanced Technology Attachment (ATA) may be used as one of the interfaces for transmitting and receiving data and, for example, may use a cable including 40 wires connected in parallel to support data transmission and data reception between the host 102 and the memory system 110. When a plurality of memory systems 110 are connected to a single host 102, the plurality of memory systems 110 may be divided into a master and a slave by using a position or a dip switch to which the plurality of memory systems 110 are connected. The memory system 110 set as the master may be used as a main memory device. The IDE (ATA) may include, for example, Fast-ATA, ATAPI, or Enhanced IDE (EIDE).

A Serial Advanced Technology Attachment (SATA) interface is a type of serial data communication interface that is compatible with various ATA standards of parallel data communication interfaces which are used by Integrated Drive Electronics (IDE) devices. The 40 wires in the IDE interface can be reduced to six wires in the SATA interface. For example, 40 parallel signals for the IDE can be converted into 6 serial signals for the SATA interface. The SATA interface has been widely used because of its faster data transmission and reception rate and its less resource consumption in the host 102 used for data transmission and reception. The SATA interface may connect up to 30 external devices to a single transceiver included in the host 102. In addition, the SATA interface can support hot plugging that allows an external device to be attached to or detached from the host 102, even while data communication between the host 102 and another device is being executed. Thus, the memory system 110 can be connected or disconnected as an additional device, like a device supported by a universal serial bus (USB) even when the host 102 is powered on. For example, in the host 102 having an eSATA port, the memory system 110 may be freely attached to or detached from the host 102 like an external hard disk.

The Small Computer System Interface (SCSI) is a type of serial data communication interface used for connecting a computer or a server with other peripheral devices. The SCSI can provide a high transmission speed, as compared with other interfaces such as IDE and SATA. In the SCSI, the host 102 and at least one peripheral device (e.g., memory system 110) are connected in series, but data transmission and reception between the host 102 and each peripheral device may be performed through a parallel data communication. In the SCSI, it is easy to connect or disconnect a device such as the memory system 110 to or from the host 102. The SCSI can support connections of 15 other devices to a single transceiver included in host 102.

Serial Attached SCSI (SAS) can be understood to be a serial data communication version of the SCSI. In the SAS, the host 102 and a plurality of peripheral devices are connected in series, and data transmission and reception between the host 102 and each peripheral device may be performed in a serial data communication scheme. The SAS can support connection between the host 102 and the peripheral device through a serial cable instead of a parallel cable, to easily manage equipment using the SAS and enhance or improve operational reliability and communication performance. The SAS may support connections of eight external devices to a single transceiver included in the host 102.

The Non-volatile memory express (NVMe) is a type of interface based at least on a Peripheral Component Interconnect Express (PCIe) designed to increase performance and design flexibility of the host 102, servers, computing devices, and the like equipped with the non-volatile memory system 110. The PCIe can use a slot or a specific cable for connecting a computing device (e.g., host 102) and a peripheral device (e.g., memory system 110). For example, the PCIe can use a plurality of pins (e.g., 18 pins, 32 pins, 49 pins, or 82 pins) and at least one wire (e.g., x1, x4, x8, or x16) to achieve high speed data communication over several hundred MB per second (e.g., 250 MB/s, 500 MB/s, 984.6250 MB/s, or 1969 MB/s). According to an embodiment, the PCIe scheme may achieve bandwidths of tens to hundreds of Giga bits per second. The NVMe can support an operation speed of the non-volatile memory system 110, such as an SSD, that is faster than a hard disk.

According to an embodiment, the host 102 and the memory system 110 may be connected through a universal serial bus (USB). The Universal Serial Bus (USB) is a type of scalable, hot-pluggable plug-and-play serial interface that can provide cost-effective standard connectivity between the host 102 and peripheral devices such as a keyboard, a mouse, a joystick, a printer, a scanner, a storage device, a modem, a video camera, and the like. A plurality of peripheral devices such as the memory system 110 may be coupled to a single transceiver included in the host 102.

Referring to FIG. 1, the error correction circuitry 138 can correct error bits of data read from the memory device 150, and may include an error correction code (ECC) encoder and an ECC decoder. The ECC encoder may perform error correction encoding of data to be programmed in the memory device 150 to generate encoded data into which a parity bit is added, and store the encoded data in the memory device 150. The ECC decoder can detect and correct error bits contained in the data read from the memory device 150 when the controller 130 reads the data stored in the memory device 150. For example, after performing error correction decoding on the data read from the memory device 150, the error correction circuitry 138 determines whether the error correction decoding has succeeded or not, and outputs an instruction signal, e.g., a correction success signal or a correction fail signal, based on a result of the error correction decoding. The error correction circuitry 138 may use a parity bit, which has been generated during the ECC encoding process for the data stored in the memory device 150, to correct the error bits of the read data entries. When the number of the error bits is greater than or equal to the number of correctable error bits, the error correction circuitry 138 may not correct the error bits and instead may output the correction fail signal indicating failure in correcting the error bits.

According to an embodiment, the error correction circuitry 138 may perform an error correction operation based on a coded modulation such as a low density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), a Block coded modulation (BCM),or the like. The error correction circuitry 138 can include at least some of circuits, modules, systems, and/or devices for performing the error correction operation based on at least one of the above-described codes.

According to an embodiment, the error correction unit 138 can enable the memory system 110 to recover or restore a multi-bit error which occurred within the memory device 150 through chipkill decoding. An error can include cases where data stored in non-volatile memory cells of the memory device 150 is incorrect or data might not be output accurately for various reasons. In an embodiment, the chipkill decoding can be performed in two different ways or in a combination of the two ways. The embodiment of the chipkill decoding can be selected or determined in accordance with the hardware structure of the memory system 110, and might be difficult to change by software designed for operations of the controller 130. When applying chipkill decoding, data bits of the memory device 150 can be separated into different code words. Here, the code word is a set of data bits and check bits that an error correction code (ECC) algorithm provides for error detection and correction. For example, 256 (64x4) bits of data can be stored in four different locations in a memory device (150). If the user data area of the memory device 150 is designed in 64-bit units, an 8-bit error correction area can be included, so that the size or length of the code word would be 72 bits. In this case, the memory system 110 can automatically correct an error in a single data bit and provide guaranteed detection in a two-data bit error. This capability can be expressed as Single Error Correction/Double Error Detection (SEC/DED). If errors occur in multiple bits in the four different locations where 256 (64x4) bits of data are stored, the decoding unit 196 can perform chipkill decoding to correct the error included in the 256 (64x4) bits of data.

According to an embodiment, to improve the performance of chipkill decoding, the memory system 110 can include more error correction bits in each code word to correct more than a single bit. The data bits and error correction bits included in the code word can be determined based on various mathematical algorithms that provide correction for multi-bit errors. For example, using a 144-bit code word including 128 data bits and 16 ECC bits, up to 4-bit errors could be corrected within a specific data bit field. However, the 4 bits that are errors may be adjacent rather than random. Even if a ratio of error correction bits to data bits is a same as in another example (e.g., 16/128 vs. 8/64), the error correction capability could be improved (e.g., the longer the code word, the more errors that can be corrected).

For example, chipkill decoding can recover uncorrectable errors using an error correction code (ECC). The chipkill decoding can be performed on a 4-bit nibble (1/2 byte). The 4-bit nibble can be called a symbol. If one nibble is incorrect, chipkill decoding can correct all 4 bits as needed. However, if more than one symbol has an error, chipkill decoding can detect the symbol with the error. The controller 130 can read 128 bits at a time together with a 16-bit check bit from the memory device 150 supporting chipkill decoding, to form a total of 144 bits of data. The 128 bits of data can be divided into 32 4-bit nibbles (N0 to N31), and the 16-bit check bit can be divided into four 4-bit nibbles (C0 to C3). For example, a Galois field could be used.

The memory interface 142 may serve as an interface for handling commands and data transferred between the controller 130 and the memory device 150, to allow the controller 130 to control the memory device 150 in response to a command or a request input from the host 102. The memory interface 142 may generate a control signal for the memory device 150 and may process data input to, or output from, the memory device 150 under the control of the processor 134 in a case when the memory device 150 is a flash memory.

For example, when the memory device 150 includes a NAND flash memory, the memory interface 142 includes a NAND flash controller (NFC). The memory interface 142 can provide an interface for handling commands and data between the controller 130 and the memory device 150. In accordance with an embodiment, the memory interface 142 can be implemented through, or driven by, firmware called a Flash Interface Layer (FIL) for exchanging data with the memory device 150.

According to an embodiment, the memory interface 142 may support an open NAND flash interface (ONFi), a toggle mode, or the like, for data input/output with the memory device 150. For example, the ONFi may use a data path (e.g., a channel, a way, etc.) that includes at least one signal line capable of supporting bi-directional transmission and reception in a unit of 8-bit or 16-bit data. Data communication between the controller 130 and the memory device 150 can be achieved through at least one interface regarding an asynchronous single data rate (SDR), a synchronous double data rate (DDR), a toggle double data rate (DDR), or the like.

The memory 144 may be used as a working memory of the memory system 110 or the controller 130, while temporarily storing transactional data for operations performed in the memory system 110 and the controller 130. For example, the memory 144 may temporarily store read data entries output from the memory device 150 in response to a read request from the host 102 before the read data entries are output to the host 102. In addition, the controller 130 may temporarily store write data entries input from the host 102 in the memory 144 before programming the write data entries in the memory device 150. When the controller 130 controls operations, such as a data read operation, a data write or program operation, a data erase operation, etc., of the memory device 150, data transmitted between the controller 130 and the memory device 150 of the memory system 110 may be temporarily stored in the memory 144.

In addition to the read data entries or write data entries, the memory 144 may store information, e.g., map data, read requests, program requests, etc. used for inputting or outputting data between the host 102 and the memory device 150. According to an embodiment, the memory 144 may include one or more of a command queue, a program memory, a data memory, a write buffer/cache, a read buffer/cache, a data buffer/cache, a map buffer/cache, and so on. The controller 130 may allocate some storage space in the memory 144 for a component which is established to carry out a data input/output operation. For example, the write buffer established in the memory 144 may be used to temporarily store target data subject to a program operation.

In an embodiment, the memory 144 may be implemented with a volatile memory. For example, the memory 144 may be implemented with a static random access memory (SRAM), a dynamic random access memory (DRAM), or both. Although FIG. 1 illustrates, for example, the memory 144 disposed within the controller 130, embodiments are not limited thereto. The memory 144 may be located within or external to the controller 130. For instance, the memory 144 may be embodied by an external volatile memory having a memory interface transferring data and/or signals between the memory 144 and the controller 130.

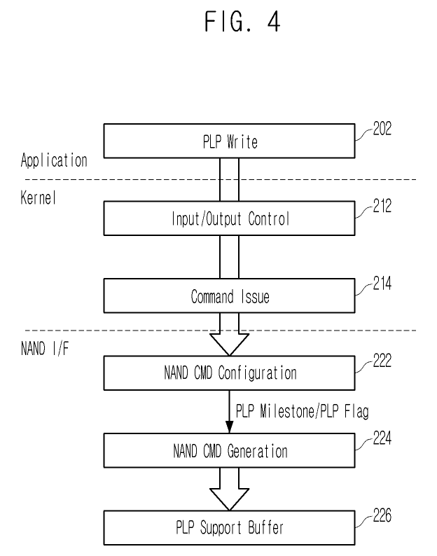

The processor 134 may control the overall operations of the memory system 110. For example, the processor 134 can control a program operation or a read operation of the memory device 150 in response to a write request or a read request entered from the host 102. According to an embodiment, the processor 134 may execute firmware to control the program operation or the read operation in the memory system 110. Herein, the firmware may be referred to as a flash translation layer (FTL). An example of the FTL will be described in detail, referring to FIGS. 3 and 4. According to an embodiment, the processor 134 may be implemented with a microprocessor, a central processing unit (CPU), or the like.

According to an embodiment, the memory system 110 may be implemented with at least one multi-core processor. The multi-core processor is a type of circuit or chip in which two or more cores, which are considered distinct processing regions, are integrated. For example, when a plurality of cores in the multi-core processor drive or execute a plurality of flash translation layers (FTLs) independently, a data input/output speed (or performance) of the memory system 110 may be improved. According to an embodiment, the data input/output (I/O) operations in the memory system 110 may be independently performed through different cores in the multi-core processor.

The processor 134 in the controller 130 may perform an operation corresponding to a request or a command input from the host 102. Further, the memory system 110 may perform an operation independent from a command or a request input from the host 102. In one case, an operation performed by the controller 130 in response to the request or the command input from the host 102 may be considered a foreground operation, while an operation performed by the controller 130 independently from the request or the command input from the host 102 may be considered a background operation. The controller 130 can perform foreground or background operations for reading, writing, or erasing data in the memory device 150. In addition, a parameter set operation corresponding to a set parameter command or a set feature command as a set command transmitted from the host 102 may be considered a foreground operation. Background operations that can be performed without a command transmitted from the host 102 by the controller 130 include garbage collection (GC), wear leveling (WL), bad block management for identifying and processing bad blocks, or the like.

According to an embodiment, substantially similar operations may be performed as both the foreground operation and the background operation. For example, when the memory system 110 performs garbage collection in response to a request or a command input from the host 102 (e.g., Manual GC), the garbage collection can be considered a foreground operation. When the memory system 110 performs garbage collection independently of the host 102 (e.g., Auto GC), the garbage collection can be considered a background operation.

When the memory device 150 includes a plurality of dies (or a plurality of chips) each including a plurality of non-volatile memory cells, the controller 130 may perform parallel processing regarding plural requests or commands input from the host 102 to improve performance of the memory system 110. For example, the transmitted requests or commands may be divided into plural groups including at least some of a plurality of planes, a plurality of dies, or a plurality of chips included in the memory device 150, and the plural groups of requests or commands are processed individually or in parallel in each plane, each die or each chip.

The memory interface 142 in the controller 130 may be connected to the plurality of dies or chips in the memory device 150 through at least one channel and at least one way. When the controller 130 distributes and stores data in the plurality of dies through each channel or each way in response to requests or commands associated with a plurality of pages including non-volatile memory cells, a plurality of operations corresponding to the requests or the commands can be performed simultaneously or in parallel in the plurality of dies or planes. Such a processing method or scheme can be considered to be an interleaving method. Because a data input/output speed of the memory system 110 increases by operating with the interleaving method, data I/O performance of the memory system 110 can be improved.

By way of example but not limitation, the controller 130 can recognize statuses of a plurality of channels (or ways) associated with the plurality of dies included in the memory device 150. The controller 130 may determine a status of each channel or each way as one of a busy status, a ready status, an active status, an idle status, a normal status, and an abnormal status. The determination of which channel or way an instruction (and/or a data) is delivered through by the controller can be associated with a physical block address. The controller 130 may refer to descriptors delivered from the memory device 150. The descriptors may include a block or page of parameters describing something about the memory device 150. The descriptors can have a predetermined format or structure. For instance, the descriptors may include device descriptors, configuration descriptors, unit descriptors, and the like. The controller 130 may refer to, or use, the descriptors to determine which channel(s) or way(s) is used to exchange an instruction or data.

Referring to FIG. 1, the memory device 150 in the memory system 110 may include a plurality of memory blocks 152, 154, 156. Each of the plurality of memory blocks 152, 154, 156 includes a plurality of non-volatile memory cells. According to an embodiment, the memory block 152, 154, 156 can be a group of non-volatile memory cells erased together. The memory block 152, 154, 156 may include a plurality of pages which is a group of non-volatile memory cells read or programmed together.

In one embodiment, each memory block 152, 154, or 156 may have a three-dimensional stack structure for a high integration. Further, the memory device 150 may include a plurality of dies, each die including a plurality of planes, each plane including the plurality of memory blocks 152, 154, 156. A configuration of the memory device 150 may be changed depending on performance of the memory system 110.

FIG. 1 illustrates the memory device 150 includes the plurality of memory blocks 152, 154, and 156. The plurality of memory blocks 152, 154, and 156 may be any of single-level cell (SLC) memory blocks, multi-level cell (MLC) memory blocks, or the like, according to the number of bits that can be stored in one memory cell. A SLC memory block includes a plurality of pages implemented by memory cells, each memory cell storing one bit of data. A SLC memory block may have higher data I/O operation performance and higher durability than the MLC memory block. The MLC memory block includes a plurality of pages implemented by memory cells, each memory cell storing multi-bit data, e.g., two or more bits of data. The MLC memory block may have larger storage capacity for the same space compared to the SLC memory block. The MLC memory block can be highly integrated in a view of storage capacity.

In an embodiment, the memory device 150 may be implemented with MLC memory blocks such as a double level cell (DLC) memory block, a triple-level cell (TLC) memory block, a quadruple-level cell (QLC) memory block, and a combination thereof. The DLC memory block may include a plurality of pages implemented by memory cells, each memory cell capable of storing 2-bit data. The TLC memory block can include a plurality of pages implemented by memory cells, each memory cell capable of storing 3-bit data. The QLC memory block can include a plurality of pages implemented by memory cells, each memory cell capable of storing 4-bit data. In another embodiment, the memory device 150 can be implemented with a block including a plurality of pages implemented by memory cells, each memory cell capable of storing five or more bits of data.

According to an embodiment, the controller 130 may use a MLC memory block included in the memory device 150 as an SLC memory block that stores one-bit data in one memory cell. A data input/output speed of the multi-level cell (MLC) memory block can be slower than that of the SLC memory block. That is, when the MLC memory block is used as the SLC memory block, a margin for a read or program operation can be reduced. For example, the controller 130 may perform a data input/output operation with a higher speed when the MLC memory block is used as the SLC memory block. Thus, the controller 130 may use the MLC memory block as a SLC buffer to temporarily store data because the buffer may require a high data input/output speed for improving performance of the memory system 110.

Further, according to an embodiment, the controller 130 can program data in a MLC a plurality of times without performing an erase operation on a specific MLC memory block included in the memory device 150. In general, non-volatile memory cells do not support data overwrite. However, the controller 130 may program 1-bit data in the MLC a plurality of times using a feature in which the MLC is capable of storing multi-bit data. For a MLC overwrite operation, the controller 130 may store the number of program times as separate operation information when 1-bit data is programmed in a MLC. According to an embodiment, an operation for uniformly levelling threshold voltages of the MLCs may be carried out before another 1-bit data is programmed in the same MLCs, each having stored 1-bit data.

In an embodiment, the memory device 150 is embodied as a non-volatile memory such as a flash memory, for example, a NAND flash memory, a NOR flash memory, or the like. In another embodiment, the memory device 150 may be implemented by at least one of a programmable ROM (PROM), an erasable ROM (EPROM), an electrically erasable ROM (EEPROM), a phase change RAM (PRAM), a magnetic RAM (MRAM), a Resistive RAM (RRAM) a phase change random access memory (PCRAM), a ferroelectrics random access memory (FRAM), a spin transfer torque random access memory (STT-RAM), and a spin transfer torque magnetic random access memory (STT-MRAM), or the like.

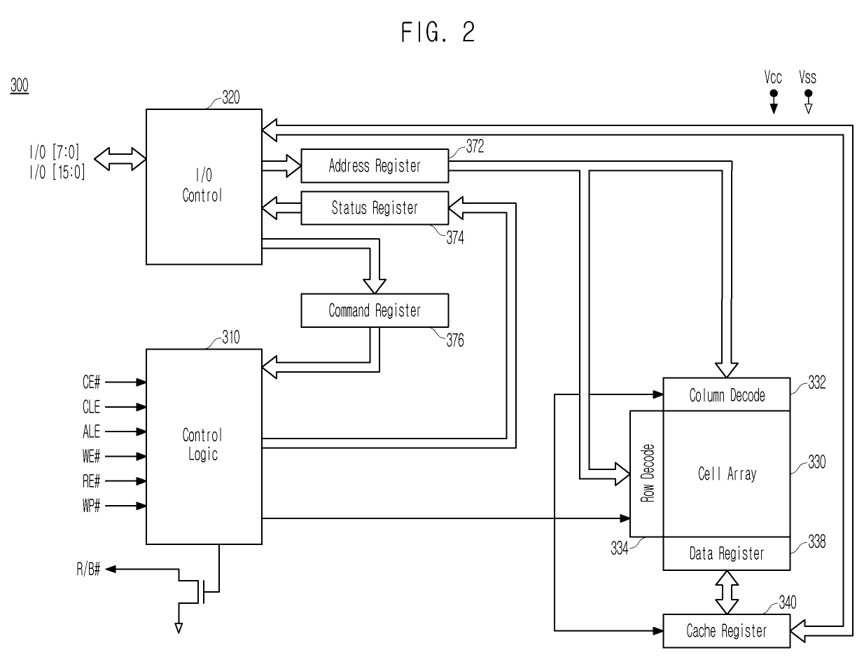

FIG. 2 illustrates a memory device 300 according to an embodiment of the present disclosure. The memory device 300 described in FIG. 2 can be understood as an example of the memory device 150 described in FIG. 1.

Referring to FIG. 2, the memory device 300 can include at least one memory die. The memory device 300 can receive or output a plurality of control signals CE#, CLE, ALE, WE#, RE#, WP#, R/B#, and receive or transmit data or operation information through channels I/O[7:0], I/O[15:0]. For example, a predetermined amount of data (e.g., 1 byte (8 bits) or 2 bytes (16 bits)) can be transmitted and received according to a channel (e.g., I/O[7:0], I/O[15:0]) connecting the memory device 300 and a controller such as the controller 130 shown in FIG. 1.

According to an embodiment, the memory device 300 can include a plurality of pins or pads. For example, the plurality of control signals CE#, CLE, ALE, WE#, RE#, WP#, R/B# can be transmitted or received through exclusively allocated pins. The control signals can include a chip enable signal CE#, a command latch enable signal CLE, an address latch enable signal ALE, a write enable signal WE#, a read enable signal RE#, a write protect signal WP#, a status signal R/B# indicating a ready state or a busy state, and the like. The control signals CE#, CLE, ALE, WE#, RE#, WP#, R/B# can be controlled (transmitted and received) by control circuitry 310 included in the memory device 300.

A control circuit 310 can perform preset operation mechanisms in response to commands and addresses input to the memory device 300. For example, when a read command is received, the control circuit 310 can manage and control components in the memory device 300 to sequentially perform operations or tasks corresponding to the read command. In addition, when the controller 130 described in FIG. 1 transmits a command to check an operation status of the memory device 300, the control circuit 310 can check information regarding the operation status and output the information to the controller 130. The control circuit 310 can be configured to perform an operation or task corresponding to a specific command or a specific interrupt according to a preset procedure in response to an input command or the interrupt, and then transmit a result of the operation or task.

The memory device 300 can include an input and output (input/output (I/O)) control circuit 320. The input/output control circuit 320 can be connected to other devices or components (e.g., a controller) through the channels I/O[7:0], I/O[15:0]. The input/output control circuit 320 in the memory device 300 can be coupled to a plurality of registers 372, 374, 376 and a cache register 340 coupled to a cell array 330.

According to an embodiment, the input/output control circuit 320 can include a chip select decoder, while the memory device 300 may include a plurality of memory chips. Chip select function may be used to activate one of the plurality of memory chips included in or connected to a memory system or a data processing system. Depending on the embodiment, the chip select decoder may be implemented with combinational logic gates that activate one specific output line in response to an input binary code. The memory system or the data processing system can use an activated output line to activate or "select" a specific chip or device from multiple devices connected to the memory system or the data processing system. For example, if there are multiple memory chips on a same bus (such as flash memory chips in solid state drives (SSDs)), for most operations it is impossible to communicate with all memory chips simultaneously because data entries or commands sent across the bus could be routed to all memory chips. Instead, a chip select signal can be used to select which chip to communicate with at any given time. The chip select decoder can manage and control data communication between multiple devices (e.g., the multiple memory chips) that share the same bus or connection lines in a system by activating one specific device based on an input select code or signal.

According to an embodiment, the memory device 300 can include the cache register 340, an address register 372, a status information register 374, and a command register 376. The cache register 340 can temporarily store data. When the memory device 300 performs a read operation, the cache register 340 can store a read data entry output from the cell array 330. When the memory device 300 performs a write operation or a program operation, the cache register 340 can store a write data entry. The address register 372 can store an address indicating a location of the cell array 330 where a read operation or a write operation is to be performed. The command register 376 can store a command to be executed by the memory device 300. The status information register 374 can store status information such as a result (failure/success) of an operation performed in the memory device 300 or readiness for performing an operation. For example, when a plurality of memory planes is included in a memory die in the memory device 300, the status information register 374 can store status information regarding each of the plurality of memory planes. Data, commands, and information transmitted or received through the input/output control circuit 320 in the memory device 300 can be controlled (e.g., transmitted, moved, or output) by the control circuitry 310.

During a read operation in the memory device 300, a row decoder 334 and a column decoder 332 can select one or more memory cells in the cell array 330 based on an address stored in the address register 372 and a control signal from the control circuitry 310. During a read operation, a read data entry output from the cell array 330 may be stored in the data register 338 and then transferred from the data register 338 to the cache register 340. The read data entry stored in the cache register 340 is transferred to the input/output control circuit 320 through input/output lines. The read data entry transmitted to the input/output control circuit 320 can be output to the controller through the channels I/O[7:0], I/O[15:0].

During a write operation or a program operation in the memory device 300, the row decoder 334 and the column decoder 332 can select one or more memory cells in the cell array 330 in response to an address stored in the address register 372 and a control signal from the control circuitry 310. During the write operation, the write data entry transferred from the controller to the input/output control circuit 320 through the channels I/O[7:0], I/O[15:0] can be stored in the cache register 340. Thereafter, the write data entry can be transferred from the cache register 340 to the data register 338. The write data entry stored in the data register 338 can be programmed in selected memory cells in the cell array 330 by the control circuitry 310.

The data register 338 and the cache register 340 can be included in a read/write circuit comprising a sense amplifier, a page buffer, or the like. According to an embodiment, page buffers or data latches included in the memory device 300 can correspond to the data register 338 and/or the cache register 340. Further, the cache register 340 is configured to temporarily store data transmitted between the data register 338 and the input/output control circuit 320. The cache register 340 may have a pipe latch structure depending on the embodiment.

A pipeline (or pipelining) system including at least one pipe latch can include an apparatus that can parallelize a plurality of data entries input and output serially. According to an embodiment, the pipeline system is applicable to the input/output control circuit 320 or the cache register 340. Further, according to an embodiment, the pipeline system may be used to compensate for delays and noise occurring in a data transmission process as a data path through which data is transmitted within the memory device 300 of the memory system becomes longer.

The cell array 330 shown in FIG. 2 can have a two-dimensional or three-dimensional structure. Hereinafter, various structures of the cell array 330 and an operation for programming data or verifying programmed data in a plurality of memory cells included in the cell array 330 will be specifically described.

FIG. 3 illustrates a power-related device according to an embodiment of the present disclosure.

Referring to FIG. 3, the power management unit 140 can include a power loss detection circuit 184 configured to detect whether power supplied from an external source is lost or unstable, an auxiliary power circuit 186 configured to supply auxiliary power based on a detection of the power loss detection circuit 184, and a power selection circuit 182 configured to select one of the external power source and the auxiliary power source. The power management unit 140 can be included in the controller 130 as described in FIG. 1. According to an embodiment, the power management unit 140 might not be included in the controller 130 but can be a separate component that is linked or engaged with the controller 130.

The power loss detection circuit 184 can monitor a level/potential of the power voltage (e.g., VDD) transmitted from the external source. If the level/potential of the power voltage becomes lower than a preset level, the power loss detection circuit 184 can determine that power loss has occurred. Power loss can occur in a case of a sudden power off or when the power voltage externally supplied is unstable.

The auxiliary power circuit 186 can be implemented in various forms depending on an embodiment. For example, the auxiliary power circuit 186 can include a capacitor. While the external power is normally supplied, the auxiliary power circuit 186 could be charged by the external power. When the power loss detection circuit 184 determines the power loss, the auxiliary power circuit 186 can supply the auxiliary power to other components. The size or capacity of the auxiliary power can be determined according to the performance of the power loss protection (PLP) that the memory system 110 can provide or guarantee.

The power selection circuit 182 can transfer the external power supplied from the outside to other components in the memory system 110 or transfer the external power to the auxiliary power circuit 186 to charge the auxiliary power circuit 186. The power loss protection controller 146 can add first information, including an input/output command input from an external device and a time point at which a task corresponding to the input/output command is performed by at least one processor, into the dump data for power loss protection in response to power loss. Referring to FIG. 3, the power loss protection controller 146 can be coupled to the host interface 132. According to an embodiment, the power loss protection controller 146 can control a procedure of generating dump data by interlocking with a plurality of components included in the controller 130.

The power loss protection controller 146 can be interlocked or engaged with a power loss protection memory block 158, which is a non-volatile memory designated to store the dump data. The power loss protection controller 146 can be configured to store the dump data in the power loss protection memory block 158, or read the stored dump data from the power loss protection memory block 158. Specific operations or tasks of the power loss protection controller 146 will be described later with reference to FIGS. 4 to 7.

Referring to FIGS. 1 to 4, the memory system 110 can include the memory 144 to improve input/output (I/O) performance and extend a lifespan of non-volatile memory devices. The memory 144 can include a DRAM-based volatile buffer. Because a volatile buffer does not guarantee data durability in an event of a sudden power-off, the memory system 110 can store all buffered data in the power-loss protection memory block 158 by using auxiliary power or backup power that could be provided from the auxiliary power circuit 186 during a power-loss protection (PLP) operation. The size of the volatile buffer set for power-loss protection (PLP) can be determined based on an amount of auxiliary power or backup power that could be provided from the auxiliary power circuit 186. For example, the volatile buffer can be set to about 1 to 5% of the storage space of the memory 144 described in FIG. 1.

According to an embodiment, the memory system 110 can add additional information regarding operations performed within the controller 130, as well as the user data stored in the internal buffer, into the dump data for power loss protection (PLP). The additional information can include metadata generated through the Flash Translation Layer (FTL) within the controller 130.

The size of the auxiliary power circuit 186 can be limited due to a chip size, and the amount of auxiliary power that the auxiliary power circuit 186 could supply can also be limited. Accordingly, the size of the dump data that could be stored or backed up through the limited auxiliary power can also be set differently depending on a scheme or a method by which the power loss protection controller 146 writes the dump data to the power loss protection memory block 158 (e.g., a page size, a programming method, number of bits stored per memory cell, etc.).

FIG. 4 illustrates an operation for power loss protection (PLP) in a memory system according to an embodiment of the present disclosure.

Referring to FIG. 4, the operation for power loss protection (PLP) can be performed through multiple layers or multiple steps. According to an embodiment, the operation for power loss protection (PLP) can be performed through an application layer (Application), a kernel layer (Kernel), and a memory interface layer (NAND I/F).

First, in the application layer (or user area), a range of data (e.g., dump data) requiring power loss protection (PLP) in response to power loss can be determined. The decision for storing determined data in the memory device 150, 300 (e.g., PLP Write) can be made in the application layer (operation 202).

In the kernel layer, in response to the decision to store dump data in the memory device 150, 300 for power loss protection (PLP), an input/output operation of the memory device 150, 300 can be controlled (operation 212). For example, to use auxiliary power for power loss protection (PLP), an input/output operation being performed or to be performed in the memory device 150, 300 can be stopped or ceased. This is because an input/output operation that is not completed in the memory device 150, 300 due to power loss cannot be guaranteed to be completed. Thereafter, the kernel layer can generate a command to store dump data for power loss protection (PLP) in the memory device 150, 300 (operation 214).

In response to the command generated in the kernel layer, the memory interface layer can configure a command to be transmitted to the memory device 150, 300 (operation 222). The command configured corresponding to the memory device 150, 300 can be determined in response to a type of the memory device 150, 300 and a data program method of the memory device 150, 300. Thereafter, the memory interface layer can generate a command for the memory device 150, 300 by adding additional information (e.g., PLP Milestone, PLP Flag) for power loss protection (PLP) into dump data (operation 224). The memory interface layer can add the generated command and dump data to a buffer that supports power loss protection (PLP) (operation 226).

Thereafter, the command and the dump data included in the buffer that supports power loss protection (PLP) can be stored in the power loss protection memory block 158 described in FIGS. 1 and 3.

As described above, to ensure stability of a log or a journal within the memory system 110 in an event of a sudden power off, it might be necessary to process it differently from the data input/output operation that is generally performed. Therefore, referring to FIGS. 4 and 5, a method or a procedure for storing data for power loss protection (PLP) in the memory device 150, 300 or the power loss protection memory block 158 could be separately set through various layers included in the power loss protection controller 146 or the controller 130. Here, the additional information for power loss protection (PLP) can include information indicating a situation being processed in the controller 130 for at least one command that is a target of, or falls within the scope of, power loss protection (PLP). The additional information for power loss protection (PLP) will be described later with reference to FIGS. 5 and 6.

According to an embodiment, the additional information (e.g., PLP Milestone, PLP Flag) for power loss protection (PLP) can include various pieces of information. For example, a power loss protection flag (e.g., PLP Flag) can be used to indicate whether it is data that should be stored in the memory device 150, 300 for power loss protection (PLP). In addition, a power loss protection milestone (e.g., PLP Milestone) can refer to a data structure that lists information on major events or tasks that can indicate progress stages in a processing procedure performed by the controller 130. Here, the processing procedure performed by the controller 130 can include at least one preset task performed by the controller 130 in the memory system 110 for a specific input/output command or an internally generated command. Here, the at least one preset task can be performed by at least one processor or core included in the controller 130.

According to the embodiment, the power loss protection milestone (e.g., PLP Milestone) can include a data structure listing information regarding major events or tasks. The information can show or indicate a progress stage or status of a mechanism or a procedure performed by the controller 130 or the power loss protection controller 146 for power loss protection (PLP). In this case, the power loss protection milestone (e.g., PLP Milestone) can provide information that is capable of identifying an error in a mechanism or a procedure performed by the controller 130 or the power loss protection controller 146 for power loss protection (PLP).

Referring to FIGS. 1 to 4, when a sudden power loss (SPL) occurs, the memory system 110 can perform an operation for power loss protection (PLP) using the auxiliary power circuit 186, and can store dump data in the memory device 150, 300 while the power is maintained for a certain period of time through the auxiliary power. Afterwards, when power is supplied again, the memory system 110 can determine consistency of the data (e.g., PLP Data) dumped for power loss protection and then attempt to recover or restore an operating state of the memory system 110 before the power loss. When a problem occurs during the operation for power loss protection (PLP) and the data is not stored normally (e.g., PLP dump), the memory system 110 cannot perform debugging for problems because the power is not supplied. When the data (e.g., PLP data) dumped for power loss protection does not include additional information about the operation or mechanism for power loss protection (PLP), it becomes difficult for the memory system 110 to find the problems after the power is supplied.

To solve this issue (e.g., difficulty of recovery or restoration), the memory system 110 can periodically include a progress status and consumption time of a main task or operation of each processor or core in the power loss protection milestone (e.g., PLP Milestone) before the power is lost through the processor or core in the controller 130. Through this procedure, when there is a problem with the data (e.g., PLP Data) dumped for power loss protection, the memory system 110 can clearly identify in what state the data was not normally processed (problem identification for recovery). Thereafter, the memory system 110 can determine a method for debugging an error or an issue.

According to an embodiment, because the memory system 110 should quickly store data in the memory device 150, 300 within a limited time after power loss occurs, the memory system 110 can maintain the designated power loss protection memory block 158 in an open state to store the power loss protection milestone (e.g., PLP Milestone) from a booting procedure that starts when power is supplied. In addition, when power loss is determined, the memory system 110 can store a record (e.g., a log) regarding a procedure of generating data (e.g., PLP Data) dumped for power loss protection in a characteristic area of the memory 144 (e.g., a volatile buffer used for supporting power loss protection (PLP)) and storing the data in the power loss protection memory block 158. The power loss protection controller 146 or the controller 130 can store the data stored in a specific area of the memory 144 in the power loss protection memory block 158. For example, the power loss protection controller 146 or the controller 130 can store the data in the power loss protection memory block 158 at a preset interval (e.g., 1 ms).

According to an embodiment, data for a power loss protection milestone (e.g., PLP Milestone) similar to a log or journal could be collected through a processor or core performing a task of a flash transition layer (FTL) in the memory system 110. A processor or core performing a task of the Flash Transition Layer (FTL) can easily monitor or track various operational states in parallel processing or multiple pipelines based on multiple processors and cores within the controller 130. In addition, a processor or core performing a task of the Flash Transition Layer (FTL) can monitor a case where a hang occurs due to over-capacity or memory shortage in other components within the controller (e.g., a system processor or core that manages and supervises the components). The monitored and collected information could be included in the power loss protection milestone (e.g., PLP Milestone) to enable later debugging.

FIG. 5 illustrates additional information for power loss protection (PLP) according to an embodiment of the present disclosure. Specifically, FIG. 5 describes the data structure of the power loss protection milestone (e.g., PLP Milestone).

Referring to FIG. 5, the power loss protection milestone 410 can include information regarding a plurality of processors or cores included in the controller 130.

According to an embodiment, the controller 130 can include a plurality of processors or cores. For example, the controller 130 can include a system core, an admin core, a host input/output core (HIO Core), a flash transition layer core (FTL Core), etc. Each core can perform a preset operation or function.

The memory system 110 can monitor a time at which each core in the controller 130 performs a preset operation or function. The memory system 110 can include information regarding the time in the power loss protection milestone 410. Here, the information regarding the time can be absolute time or relative time information. For example, when the start of an operation sequence for a specific command is taken as a reference (e.g., '0' ns), the time or status at which each core starts, takes or completes an operation or function, etc., included in the operation sequence could be included as the relative time information. According to an embodiment, the power loss protection milestone 410 can include the absolute time at which each core starts, takes or completes performing an operation or function, etc., based on the absolute time at which the operation sequence for power loss protection (PLP) starts.

According to an embodiment, in the case of a memory system, a specific operation sequence can be performed, and information regarding whether the operation sequence is normally completed can be recorded in a log. Whether a specific operation sequence is completed can be recorded in a log as information such as a flag or signature, so that it can be known whether the operation sequence is normally performed based on the log record. In this case, whether the operation sequence is completed can be checked only. However, because the operation sequence may contain an error, there may be insufficient information to debug the operation sequence. When information that can indicate a processing status or a processing time in response to a specific operation sequence is included in the log or additional information such as a power loss protection milestone 410, the memory system 110 can perform active recovery or restoration (e.g., debugging) to an error based on the log or additional information.

The memory system 110 can attempt to restore or recover the operating state before power loss based on the data stored in the power loss protection memory block 158 designated for power loss protection (PLP). However, if it is difficult for the memory system 110 to restore or recover the operating state before power loss based on the data stored in the power loss protection memory block 158, the memory system 110 can check the power loss protection milestone 412.

FIG. 6 illustrates a validation process of a write operation (e.g., PLP Dump) for power loss protection (PLP) based at least on additional information for the power loss protection (PLP) according to an embodiment of the present disclosure. Specifically, FIG. 6 illustrates an example of a debugging method using the power loss protection milestone 410.

Referring to FIG. 6, the memory system 110 can compare information stored in two pages within the power loss protection memory block 158. When a first power loss protection milestone 412 is compared with a second power loss protection milestone 414, the memory system 110 can recognize that there is information about the time from when a host input/output core (HIO Core) detects a sudden power loss (SPL) to when the host input/output core (HIO Core) generates dump data stored in the power loss protection memory block 158 (e.g., HioCoreDetectTime: 1030us, HwStopDoneTime: 1050us). However, the time point information indicating a detection of the operation of the administration core (Admin Core) in the first power loss protection milestone 412 and the second power loss protection milestone 414 is stored as '0' (e.g., AdminCoreDetectTime: 0).

Based on the first power loss protection milestone 412 and the second power loss protection milestone 414, the memory system 110 can determine that the host input/output core (HIO Core) detected the sudden power loss (SPL), but the administration core (Admin Core) did not detect the sudden power loss SPL. Furthermore, the memory system 110 can infer that the administration core (Admin Core) can be in a hanging state for a reason other than the sudden power loss (SPL) or in a disable state (e.g., Disable) that occurrence or reception of an interrupt is abnormal due to reasons such as entering a serious operation state.

As described above, when the process of storing data for power loss protection (PLP) in the memory device 150, 300 is not completed normally for any reason, the memory system 110 according to an embodiment of the present disclosure can analyze and determine which operation or function was performed or not performed in each core included in the memory system 110 before the power loss based on the power loss protection milestones 410, 412, 414 stored in the memory device 150, 300. Based on this analysis and determination, the memory system 110 can improve safety and reliability in the recovery and restoration process after the power loss.

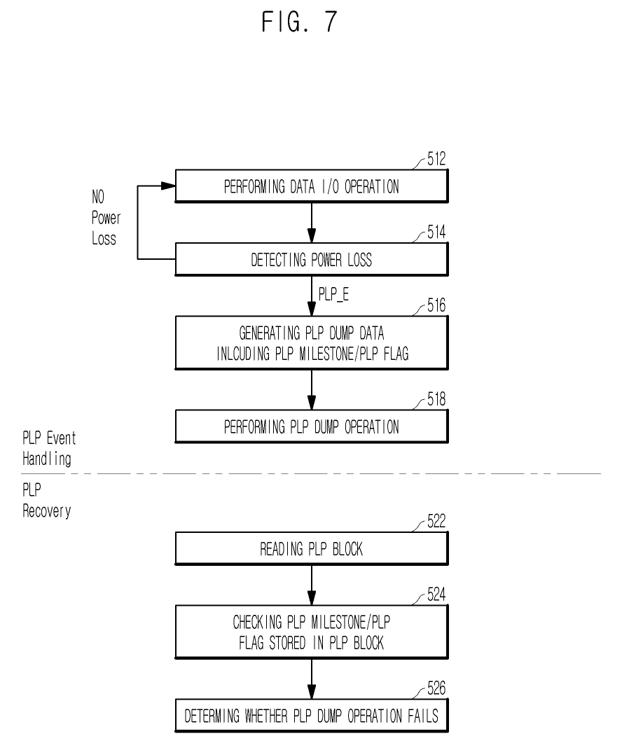

FIG. 7 illustrates an operation for power loss protection (PLP) according to an embodiment of the present disclosure.

Referring to FIG. 7, the memory system 110 can perform two procedures in relation to power loss. For example, one is a process for handling a power loss protection (PLP) event (e.g., PLP Event Handling), and the other is a process for recovering data for the power loss protection (PLP) that is performed when power is supplied after power loss (e.g., PLP Recovery).

The memory system 110 can perform a data input/output operation (operation 512). The memory system 110 can monitor and detect power loss while performing the data input/output operation (operation 514). When there is no power loss in the memory system 110 (e.g., NO Power Loss), the memory system 110 can continue to perform the data input/output operation (operation 512).

When a power loss is detected in the memory system 110, the memory system 110 can generate an event (e.g., PLP_E) for power loss protection. To process a power loss protection event (e.g., PLP Event), the memory system 110 can generate dump data (e.g., PLP Dump Data) including additional information (e.g., PLP Milestone/PLP Flag) in the power loss protection controller 146 included in the controller 130 (operation 516).

The memory system 110 can store the dump data, which is data and information configured for power loss protection (PLP) while auxiliary power is supplied, in the power loss protection memory block 158 of the memory device 150, 300 (operation 518). The memory device 150, 300 can complete an operation corresponding to the power loss protection event (e.g., PLP Event) by programming the transmitted data into the memory cell.

When power is supplied to the memory system 110 after power loss, the memory system 110 can read the data programmed in the power loss protection memory block 158 of the memory device 150, 300 (operation 522). When power is supplied to the memory system 110, the memory system 110 can return to the operating state before the power loss based on the data read from the power loss protection memory block 158. In addition, an external device (e.g., host, 102) that is coupled to the memory system 110 can expect that the commands and data transmitted to the memory system 110 are normally processed. After the memory system 110 reads the data stored in the power loss protection memory block 158, the memory system 110 can process or reprocess the read data for recovery or restoration.

The memory system 110 can perform data recovery for power loss protection (PLP) and store related data (e.g., write data, metadata, map data, etc.) in other memory blocks 152, 154, 156 other than the power loss protection memory block 158 used for the power loss protection (PLP) in the memory device 150, 300. The memory block that stores the recovered data can include non-volatile memory cells capable of storing multi-bit data. In response to a command processed through a recovery operation, the memory system 110 can transmit a response including the processed result to an external device.

Moreover, the memory system 110 may not be able to return to a state before power loss based on data stored in the power loss protection memory block 158. For example, there may be a problem such as data corresponding to at least one command or related data not being normally performed before power loss or not being normally stored in the memory device 150, 300 in response to power loss. In this case, the memory system 110 can check additional information (e.g., PLP Milestone/PLP Flag) stored in the power loss protection memory block (e.g., PLP Block) 158 (operation 524).

The memory system 110 can check which stage or procedure in the controller 130 the corresponding data was processed to based on the additional information (e.g., PLP Milestone/PLP Flag) stored in the power loss protection memory block (e.g., PLP Block) 158 (operation 524). Based on the additional information (e.g., PLP Milestone/PLP Flag) stored in the power loss protection memory block (e.g., PLP Block) 158, the memory system 110 may not be able to know the operating state within the controller 130 before the power loss. In this case, the memory system 110 can determine that the dump data stored for the power loss protection (PLP) was not normally stored (operation 526).

According to an embodiment, the memory system 110 can determine that the entire dump data stored for the power loss protection (PLP) was not normally stored. Based on the additional information (e.g., PLP Milestone/PLP Flag) stored in the power loss protection memory block (e.g., PLP Block) 158, the memory system 110 can individually determine and decide whether the power loss protection (PLP) is performed (e.g., success or failure) for each command being processed or scheduled to be processed before the power loss.

As described above, when the storage of dump data (e.g., PLP Dump) stored for power loss protection (PLP) is incompletely terminated for some reason, the memory system 110 can infer the cause based on the additional information. For example, in response to a sudden power loss (sudden power off, sudden power loss), the memory system 110 can clearly identify an error in the processing of a specific command or an error during the PLP operation of the command through the additional information (e.g., PLP Milestone/PLP Flag), which is information that can infer the progress of the mechanism for the power loss protection (PLP) included in the data to be stored for the power loss protection (PLP). Based on this information, the memory system 110 can perform debugging on the dump data stored for the power loss protection (PLP) during the recovery process for the power loss protection (PLP), thereby improving the operational safety of the memory system 110.

As above described, according to an embodiment of the present disclosure, a memory device or a memory system can insert time information when the data is processed to a dump data, while storing data in response to power instability or power loss, so as to easily track in which step or in which situation the data is stored, and easily determine whether the data is valid based on the time information. Through this procedure, the operational reliability of the memory device or the memory system could be improved.

In the memory device or the memory system according to an embodiment of the present disclosure, when the operation is stopped due to an error or interrupt, the reliability of the process of recovering or restoring the operation state before the stop could be increased, and the cause of the operation before the stop could be easily checked, so there is an advantage of improving issues occurring in operations performed in response to an error or an interrupt.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments, may transform the computer, processor, controller, or other signal processing device into a special-purpose processor for performing the methods herein.

Also, another embodiment may include a computer-readable medium, e.g., a non-transitory computer-readable medium, for storing the code or instructions described above. The computer-readable medium may be a volatile or non-volatile memory or other storage device, which may be removably or fixedly coupled to the computer, processor, controller, or other signal processing device which is to execute the code or instructions for performing the method embodiments or operations of the apparatus embodiments herein.

The controllers, processors, control circuitry, devices, modules, units, multiplexers, logic, interfaces, decoders, drivers, generators and other signal generating and signal processing features of the embodiments disclosed herein may be implemented, for example, in non-transitory logic that may include hardware, software, or both. When implemented at least partially in hardware, the controllers, processors, control circuitry, devices, modules, units, multiplexers, logic, interfaces, decoders, drivers, generators and other signal generating and signal processing features may be, for example, any of a variety of integrated circuits including but not limited to an application-specific integrated circuit, a field-programmable gate array, a combination of logic gates, a system-on-chip, a microprocessor, or another type of processing or control circuit.

When implemented at least partially in software, the controllers, processors, control circuitry, devices, modules, units, multiplexers, logic, interfaces, decoders, drivers, generators and other signal generating and signal processing features may include, for example, a memory or other storage device for storing code or instructions to be executed, for example, by a computer, processor, microprocessor, controller, or other signal processing device. The computer, processor, microprocessor, controller, or other signal processing device may be those described herein or one in addition to the elements described herein. Because the algorithms that form the basis of the methods (or operations of the computer, processor, microprocessor, controller, or other signal processing device) are described in detail, the code or instructions for implementing the operations of the method embodiments, may transform the computer, processor, controller, or other signal processing device into a special-purpose processor for performing the methods described herein.

While the present teachings have been illustrated and described with respect to specific embodiments, it will be apparent to those skilled in the art in light of the present disclosure that various changes and modifications may be made without departing from the spirit and scope of the disclosure as defined in the following claims. Furthermore, the embodiments may be combined to form additional embodiments.

What is claimed is:

1. A memory system comprising:
a memory device including at least one data storage area; and
a memory controller configured to, through at least one processor, perform a plurality of tasks corresponding to input/output commands for storing write data in the memory device or outputting stored data from the memory device, and add first information regarding a time point associated with an operation or function performed by the at least one processor into dump data for power loss protection.

2. The memory system according to claim 1, wherein the at least one processor comprises N processors,
wherein the N processors independently perform the plurality of tasks, and
wherein the first information comprises information regarding a time taken for the N processors to perform the plurality of tasks.

3. The memory system according to claim 1, wherein the memory device comprises a first memory block designated for the power loss protection, and
wherein the memory controller is configured to store the dump data including the first information in the first memory block.

4. The memory system according to claim 1, wherein the memory controller is configured to generate the first information for each of the input/output commands, and
wherein the first information indicates a completed process in a series of processes in which the input/output commands are processed within the memory controller.

5. The memory system according to claim 4, wherein the first information comprises a time taken for the task performed by each of the at least one processor to be completed, and
wherein the first information comprises '0' or a null value when the at least one processor has not completed the plurality of tasks or the plurality of tasks has not been performed by the at least one processor.

6. The memory system according to claim 1, wherein the memory controller is configured to:
read the dump data from the memory device after power is supplied again after a power loss; and
recover or restore the operating state before the power loss based on the dump data.

7. The memory system according to claim 6, wherein the memory controller is configured to determine whether at least one of the input/output commands has failed based on the first information included in the dump data, when at least a part of the recovery or restoration fails.

8. The memory system according to claim 7, wherein the memory controller is configured to transmit a response for the input/output commands to an external device when it is determined whether at least one of the input/output commands has failed.

9. The memory system according to claim 1, wherein the memory controller is configured to:
generate an internal command other than the input/output commands;
perform at least one task for the internal command through the at least one processor; and
add the first information regarding the at least one task into dump data for the power loss protection.

10. The memory system according to claim 9, wherein the memory controller is configured to:
recover or restore the operating state for the internal command after power is supplied again after a power loss; and
re-generate the internal command when at least a part of the recovery or restoration fails.

11. A method of operating a memory system comprising:
performing a plurality of tasks corresponding to input/output commands through at least one processor;
monitoring a time point or a status associated with the at least one task among the plurality of tasks performed by the at least one processor;
adding, into dump data, first information regarding the time point or the status associated with the at least one task or operation, after an operation for power loss protection is begun; and
storing the dump data including the first information in a memory block designated for the power loss protection.

12. The method according to claim 11, wherein the at least one processor comprises N processors,
wherein the N processors independently perform the plurality of tasks, and
wherein the first information comprises information regarding a time taken for the N processors to perform the plurality of tasks.

13. The method according to claim 11, wherein the first information generated for each of the input/output commands indicates a completed stage in a series of processes in which the input/output commands are processed within a controller.

14. The method according to claim 11, wherein the first information comprises information regarding a time taken for the at least one task performed by each of the at least one processor to be completed, and
wherein the first information comprises '0' or a null value when a task among the plurality of tasks is not completed nor performed by the at least one processor.

15. The method according to claim 11, further comprising:
reading the dump data from the memory block after power is supplied after a power loss; and
recovering or restoring an operating state before the power loss based at least on the dump data.

16. The method according to claim 15, further comprising:
determining whether at least one of the input/output commands has failed based on the first information included in the dump data, when at least a part of recovery or restoration fails; and
transmitting a response to each of the input/output commands to an external device when recovery or restoration failure of each of the input/output commands is determined.

17. A data storage device comprising:
a power circuit configured to detect whether external power is lost or unstable and supply one of an external power source or an auxiliary power source; and
a power loss protection controller configured to add first information, including an input/output command input from an external device and a time point associated with at least one task for the input/output command performed by at least one processor in response to a power loss, into dump data for power loss protection; and
a non-volatile memory designated to store the dump data.

18. The data storage device according to claim 17, wherein the power circuit comprises:
a power loss detection circuit configured to detect whether the external power source is lost or unstable;
an auxiliary power circuit configured to supply the auxiliary power source in response to a determination of the power loss detection circuit; and
a power selection circuit configured to select one of the external power source and the auxiliary power source.

19. The data storage device according to claim 17, wherein the power loss protection controller is configured to:
monitor the time point associated with at least one task performed by the at least one processor for the input/output command; and
generate the first information when auxiliary power is supplied through the power circuit.

20. The data storage device according to claim 17, wherein the power loss protection controller is configured to:
read the dump data from the non-volatile memory after the external power is supplied after the power loss; and
recover or restore an operating state of the data storage device before the power loss based on the dump data.
